(19) United States
(12) Patent Application Publication
(10) Pub. No.: US 2026/0328638 A1
(43) Pub. Date: Oct. 22, 2026

(54) QUANTITATIVE METHOD OF MEASURING LEAKAGE VOLUME

(71) Applicant: CURAPIPE SYSTEM LTD., Kiryat Malachi (IL)

(72) Inventor: Peter PAZ, Har Adar (IL)

(21) Appl. No.: 19/655,818

(22) Filed: Apr. 23, 2026

Related U.S. Application Data
(63) Continuation of application No. 17/760,626, filed on Sep. 10, 2020, now abandoned.
(60) Provisional application No. 62/901,275, filed on Sep. 17, 2019.

(51) Int. Cl. G01M 3/28; G01F 1/36

(52) U.S. Cl. CPC G01M 3/2815; G01F 1/36

(57) ABSTRACT

The present invention provides methods and apparatus for determining a fluid leakage volume in a pipeline complex, the method including providing a leakage measurement apparatus, determining a fluid flowrate through the leakage measurement apparatus and adjusting an externally controlled pressure located at a pressure point in said apparatus thereby determining said fluid leakage volume.

### FIELD OF THE INVENTION

The present invention relates generally to pipeline leakage measurement and remediation methods, and more specifically to methods and apparatus for determining the efficiency of novel in-pipe repair methods and quantitative leakage level measurements.

### BACKGROUND OF THE INVENTION

In recent years, water conservation has become increasingly important for water utilities globally. Policy makers, as well as utility managers, realize that the reduction of water system leakage is important from environmental, political and commercial points of view.

Current methodologies for leak detection aim at localizing the leakage area as best as possible with the aim of directing repair by means of excavating and sealing the leak. However, these methods deliver diminishing returns when remaining leaks become smaller and harder to locate. In addition to becoming non-efficient excavation is socially disruptive and so new in-pipe repair methods have emerged to further reduce leakage. In high diameter pipes, these may be done by robots or even humans on mobile equipment but on smaller diameters where much of the leakage exists this is not possible. Patents such as U.S. Pat. Nos. 10,302,235 and 10,302,236 deal with a novel intervention applying a pig train of materials that moves down a pipe and seal leaks remotely. In such cases, it would useful to have a tool which can provide valuable information regarding the probability of an efficient seal prior to the intervention itself as a decision making tool as well as measuring the level of leakage that may be sealed in a given pipe section.

There thus remains a need to provide improved decision-making tools for deciding on whether to try to intervene and seal leak or not and further for determining whether an efficient seal is feasible or not.

### SUMMARY OF THE INVENTION

It is an object of some aspects of the present invention to provide quantitative methods for determining leakage volumes within a pipeline or pipeline complex.

It is another object of some aspects of the present invention to provide quantitative methods for determining leakage volumes within a subterranean pipeline network.

In some embodiments of the present invention, improved methods and apparatus are provided for determining leakage volumes within a pipeline or pipeline complex.

In some embodiments of the present invention, improved methods and apparatus are provided for improved decision-making for deciding on whether to try to intervene and seal leak or not.

In some embodiments of the present invention, improved methods and apparatus are provided for determining whether an efficient seal is feasible or not in a pipeline or pipeline network.

In some embodiments of the present invention there is provided a method and apparatus to determine a metric by which a leak or leaks in a subterranean pipeline network or pipeline network can be classified for the purposes of in-pipe leak repair remediation.

The present invention provides a methodology for quantifying leakage in pipeline networks as well as determining a metric by which the integrity of an in-pipe leak repair can be determined. The methodology may be applied threefold:
1. Measuring the aggregate leakage in differing cohorts of pipelines (e.g. materials, pressure zones, soil types) for the purpose of establishing benchmarks when conducting water loss audits and assessments of buried infrastructure integrity.
2. For the purpose of conducting a repair intervention based on the inventive sealant compositions and methodologies and measuring leakage reduction effectiveness of said repair during or after completion of said repair intervention.
3. For the purpose of predicting ahead of time the leakage reduction effectiveness of conducting a repair intervention based on the inventive sealant compositions and methodologies as a decision tool and comparing to the actual leakage reduction effectiveness of said repair after conducting a repair intervention based on the said inventive sealant compositions and methodologies.

There is thus provided according to an embodiment of the present invention, a method for determining a fluid leakage volume in a pipeline complex, the method including;
a. providing a leakage detection apparatus;
b. determining a first fluid flowrate through at least part of the leakage detection apparatus; and
c. adjusting at least one of the first fluid flowrate and an externally controlled pressure located at least one pressure point in the apparatus, thereby determining the fluid leakage volume in the pipeline complex.

Additionally, according to another embodiment of the present invention, the pipeline complex is at least partially one of underground and underwater.

Moreover, according to another embodiment of the present invention, the pipeline complex is at least one of underground and underwater.

Further, according to another embodiment of the present invention, the method further includes applying different pressure heads and measuring the resultant leakage flow rate at the at least one pressure point in the pipeline complex.

Yet further, according to another embodiment of the present invention, the method further includes applying different pressure heads and measuring the resultant leakage flow rate in the pipeline complex.

Additionally, according to another embodiment of the present invention, the fluid leakage rate is determined according to the Torricelli equation:

Q=C_{d}A√2gh [1]

where Q is the leakage flow rate through the orifice; k₂ a discharge coefficient; A the leak area; g the acceleration due to gravity; and h the pressure head at the orifice.

There is thus provided according to another embodiment of the present invention, a statistical method for detecting leakage in a section of a pipeline, the method including;
a. monitoring standard water uses over time during an off-peak period;
b. detecting water usage patterns associated with repeated use types;
c. mapping the repeated use types; and
d. detecting a baseline level usage indicative of the section leakage or non-leakage thereof.

Additionally, according to another embodiment of the present invention, the repeated use types are selected from the group consisting of, a toilet flush, a washing machine cycle, a dishwasher cycle, a shower, a bath, a garden sprinkler, a hose activation, a kitchen tap usage; a bathroom tap usage, any common usage during common sleeping hours of the night and combinations thereof.

Furthermore, according to another embodiment of the present invention, the baseline level is indicative of a quantity of pipe section leakage.

Additionally, according to another embodiment of the present invention, steps a)-d) are repeated for different sections of the pipeline to map an entire pipeline.

Importantly, according to another embodiment of the present invention, steps a)-d) are repeated for a plurality of pipelines to map leakage in an entire network of pipelines.

Furthermore, according to another embodiment of the present invention, a leakage of each section is quantified to determine the highest leakage sections for repair.

Usefully, according to another embodiment of the present invention, the method further includes prioritizing the highest leakage sections for repair.

Usefully, according to another embodiment of the present invention, the method further includes a method and apparatus to determine a metric by which a leak or leaks in the current pipe section can be classified for the purposes of in-pipe leak repair remediation specifically the probability of effecting an efficient seal.

Additionally, according to another embodiment of the present invention, the method further includes repairing the highest leakage sections with the highest probability of effecting an efficient seal.

Additionally, according to another embodiment of the present invention, the method further includes repairing the highest leakage sections with medium probability effecting an efficient seal.

Thereafter, according to another embodiment of the present invention, the method further includes next repairing the lower leakage sections with the highest probability of effecting an efficient seal.

Thereafter, according to another embodiment of the present invention, the method further includes next repairing the lower leakage sections with medium probability effecting an efficient seal.

### EMBODIMENTS

1. A method for measuring a fluid leakage volume in a pipeline network, the method comprising:
   a. providing a leakage measurement apparatus;
   b. determining a fluid flowrate through said leakage measurement apparatus; and
   c. adjusting an externally controlled pressure located at a pressure point in said apparatus thereby determining said fluid leakage volume.
2. A method according to embodiment 1, wherein said pipeline complex is at least partially one of underground and underwater.
3. A method according to embodiment 2, wherein said pipeline complex is at least one of underground and underwater.
4. A method according to embodiment 1, further comprising measuring pressure of said pressure point in said pipeline complex.
5. A method according to embodiment 1, wherein said leakage measurement apparatus comprises a water inlet valve at a first end of a conduit, a pressure gauge in fluid connection with said conduit and a fluid flowmeter in fluid connection with said conduit.
6. A method according to embodiment 1, wherein said conduit is in fluid connection with said pipeline complex at a second end thereof.
7. A method for determining the probability of being able to seal a leakage, the method comprising:
   a. determining an Orifice Area Expansion Factor (OAEF) threshold; and efficiency; and
   b. determining said probability responsive to the OAEF threshold.
8. A method according to embodiment 7, wherein an increase in OAEF is indicative of poorer structural integrity of said orifice.
9. A method according to embodiment 7, wherein an increase in OAEF is indicative of a lower probability of achieving an efficient seal of said leakage at said orifice.
10. A method for reducing leakage in a pipeline or pipeline network, the method comprising:
   a. determining a pre-intervention leakage level according to the method of embodiment 1;
   b. performing an intervention to stop the leakage; and
   c. determining a post-intervention leakage level according to the method of embodiment 1.
11. A method according to embodiment 10, wherein the leakage level is reduced by at least 10, 20, 30, 40, 50, 60, 70, 80, 90, 95, 99 and 99.9%.
12. A method according to embodiment 10, wherein the post-intervention leakage level is less than 10, 20, 30, 40, 50, 60, 70, 80, 90 95, 99 and 99.9% of the pre-intervention leakage level.
13. A statistical method for measuring leakage in a section of a pipeline, the method comprising:
   a. monitoring standard water uses over time during an off-peak period;
   b. detecting water usage patterns associated with repeated use types;
   c. mapping said repeated use types; and
   d. measuring a baseline level flowrate over said off-peak period indicative of the section leakage or non-leakage thereof.
14. A method according to embodiment 13, wherein said repeated use types are selected from the group consisting of, a toilet flush, a washing machine cycle, a dishwasher cycle, a shower, a bath, a garden sprinkler, a hose activation, a kitchen tap usage, a bathroom tap usage and combinations thereof.
15. A method according to embodiment 13, wherein said baseline level is indicative of a quantity of section leakage.
16. A method according to embodiment 13, wherein steps a)-d) are repeated for different sections of said pipeline to map an entire pipeline.
17. A method according to embodiment 13, wherein steps a)-d) are repeated for a plurality of pipelines to map leakage in an entire network of pipelines.
18. A method according to embodiment 17, wherein a leakage of each section is quantified to determine the highest leakage sections for repair.
19. A method according to embodiment 18, further comprising analyzing said highest leakage sections for repair.
20. A method according to embodiment 19, further comprising prioritizing said highest leakage sections for repair.
21. A method according to embodiment 18, further comprising repairing said highest leakage sections.
22. A method according to embodiment 21, further comprising next repairing lower leakage sections.
23. A method according to embodiment 13, further comprising performing the following steps at least once:
   a. providing a leakage measurement apparatus;
   b. determining a fluid flowrate through said leakage measurement apparatus;
and
   c. adjusting an externally controlled pressure located at a pressure point in said apparatus thereby determining said fluid leakage volume.
24. A method for measuring a fluid leakage volume in a pipeline network or single pipeline, the method comprising:
   a. providing a leakage detection apparatus as described herein;
   b. measuring leakage flow rates for different externally adjusted and controlled pressure heads through at least part of said leakage measurement apparatus; and
   c. adjusting at least one of the first fluid flowrate and an externally controlled pressure located at a pressure point in the apparatus, thereby determining the fluid leakage volume in the pipeline network or single pipeline.
25. A method according to embodiment 24, wherein said pipeline complex is at least partially one of underground and underwater.
26. A method according to embodiment 25, wherein said pipeline complex is at least one of underground and underwater.
27. A method according to embodiment 24, further comprising measuring leakage flow rates for different externally adjusted and controlled pressure heads at a pressure point through said leakage measurement apparatus to determine the levels of leakage flow.
28. A method according to embodiment 24, further comprising measuring leakage flow rates for different externally adjusted and controlled pressure heads at least one pressure point through said leakage measurement apparatus, wherein the leakage flow rate Q is determined by the following equation:—

Q=C_{d}A(2gh)^{0.5} [1]
wherein Q is the leakage flow rate through the orifice; Ca a discharge coefficient; A the leak area; g the acceleration due to gravity; and h the pressure head at the orifice.
29. A statistical method for measuring leakage in a section of a pipeline, the method comprising:
   a. monitoring standard water uses over time during an off-peak period;
   b. detecting water usage patterns associated with repeated use types;
   c. mapping said repeated use types; and
   d. measuring a baseline level flowrate over said off-peak period indicative of the section leakage or non-leakage thereof.
30. A method according to embodiment 29, wherein said repeated use types are selected from the group consisting of, a toilet flush, a washing machine cycle, a dishwasher cycle, a shower, a bath, a garden sprinkler, a hose activation, a kitchen tap usage; a bathroom tap usage and combinations thereof.
31. A method according to embodiment 30, wherein said baseline level is indicative of a quantity of section leakage.
32. A method according to embodiment 31, wherein steps a)-d) are repeated for different sections of said pipeline to map an entire pipeline.
33. A method according to embodiment 31, wherein steps a)-d) are repeated for a plurality of pipelines to map leakage in an entire network of pipelines.
34. A method according to embodiment 33, wherein a leakage of each section is quantified to determine the highest leakage sections for repair.
35. A method according to embodiment 34, further comprising analyzing said determine the highest leakage sections for repair.
36. A method according to embodiment 35, further comprising prioritizing said highest leakage sections for repair.
37. A method according to embodiment 36, further comprising repairing said highest leakage sections.
38. A method according to embodiment 37, further comprising next repairing lower leakage sections.
39. A method according to embodiment 38, further comprising performing the following steps at least once:
   a. providing a leakage measurement apparatus;
   b. determining a fluid flowrate through said leakage measurement apparatus; and
   c. adjusting an externally controlled pressure located at a pressure point in said apparatus thereby determining said fluid leakage volume.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified schematic illustration of a monitoring system for a section of a mains pipe and associated service pipes, in accordance with an embodiment of the present invention;

FIG. 2A is a simplified chart of water use and losses over time for a section of a mains pipe, in accordance with an embodiment of the present invention;

FIG. 2B is a simplified chart of water use and losses over time for a section of a mains pipe, in accordance with an embodiment of the present invention; and

FIG. 2C is a simplified chart of water use and losses over time for a section of a mains pipe, in accordance with an embodiment of the present invention.

In all the figures similar reference numerals identify similar parts.

### DETAILED DESCRIPTION OF THE EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

In some embodiments of the present invention there is provided a method and apparatus to determine a metric by which a leak or leaks in a subterranean pipeline network or pipeline network can be classified for the purposes of in-pipe leak repair remediation, using methods and systems as disclosed in U.S. Pat. Nos. 10,302,235, 10,288,206 and 10,302,236, incorporated herein by reference.

The classification relates to the decreased probability of achieving an efficient seal due to impaired structural integrity of a leak orifice, in particular (but not only) the effect of pressure on holes and cracks in water supply pipes. Of particular interest are the behaviors of different types of leak orifices (e.g. round holes, longitudinal, circumferential and spiral cracks) when pressurized both in ferrous and plastic pipes where elastic behavior may occur. For our purposes an efficient seal is enabled in a leak orifice when the area of said orifice does not measurably increase (or decrease) when the pressure head is increased.

The following assumptions are made:
1. The buried pipe section is of limited length (typically less than 1 km).
2. The said pipe has one single leak, or in the event that more are present, a single dominant leak in terms of volumetric flow or if of similar volumetric flow have similar characteristics.
3. The pipe section together with any associated branches or service pipes are hydraulically isolated from the rest of the network without any let by or leakage between the pipe section and the rest of the network.
4. The pipe section is externally pressurized from a single point and whose pressure head is externally measured and controlled.
5. The resultant pressure head in the pipe section, branches and service pipes is constant and stable (i.e. no elevations in the pipe section and no pressure transients during measurements).
6. The leak/s are buried in the pipe section and not accessible for visible inspection.

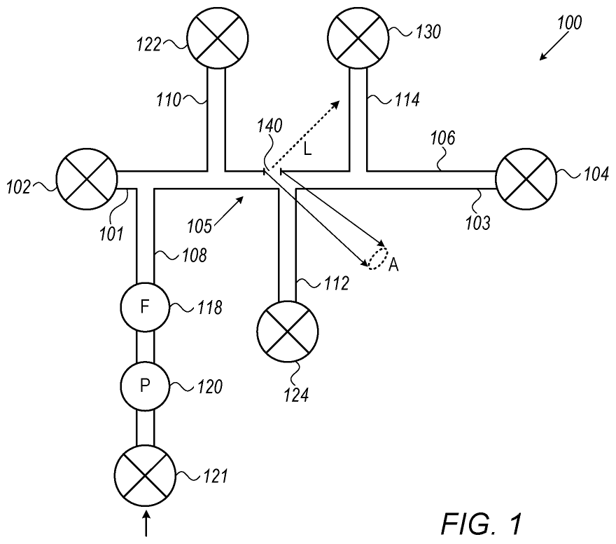

Reference is now made to FIG. 1, which is a simplified schematic illustration of a monitoring system 100 for a section 106 of a mains pipe 105 and associated service pipes 110, 112 and 114 in accordance with an embodiment of the present invention. The section of mains pipe 106 is contained by a first valve 102 at one end 101 and by a second valve 104 at a second end 103. Pipe 108 is used for introducing water via 108 and releasing the water via 116. The mains pipe has a leakage, L with an orifice 140 of a cross-sectional area, A (leak area in equation 1, or A₀ in equation 2 hereinbelow initially at time t₀,). This cross sectional area may increase under at least one of increased pressure (ΔP) and/or increased time (Δt) and may be measured at a later time to be of a cross-sectional area, denoted A.

The pipes 108, 110, 112 and 114 typically each comprise a respective valve or tap 121, 122, 124, and 130 for closing their water supply.

Pipe 108 also comprises a flowmeter, F, 118 and a pressure meter P, 120.

The advantages of the systems, apparatus and methods of the present invention include, inter alia:
a) providing high resolution as to the level of aggregate leakage within a pipeline network or district metered area (DMA);
b) providing a quantitative indication of the most significant leakage pipeline sections;
c) providing data to prioritize the pipeline sections requiring urgent repair and less urgent repair;
d) providing leakage measurement apparatus which can quantify leakage at different operating pressures in a pipeline section;
e) being able to isolate small sections of a DMA for leakage analysis; and
f) repairing the leaking pipeline sections to significantly reduce DMA leakage.
g) Measure the level of aggregate leakage in a post-repair pipe section and comparison to the same pre-repair.
h) Predicting ahead of time the leakage reduction effectiveness of conducting a repair intervention based on the inventive sealant compositions and methodologies as a decision tool and comparing to the actual leakage reduction effectiveness of said repair after conducting a repair intervention based on the said inventive sealant compositions and methodologies.

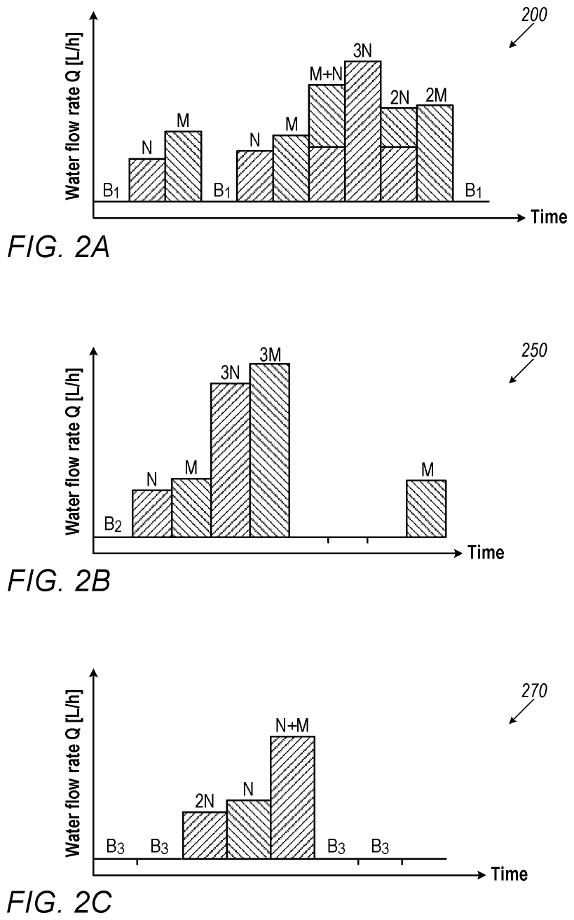

Reference is now made to FIG. 2A, which is a simplified chart 200 of water use and losses over time for a section of a mains pipe, in accordance with an embodiment of the present invention (not to scale). The total usage of water can be statistically mapped over time, say for section 106 of mains pipe 105 (FIG. 1A). In a first scenario, the total water usage/flowrate is mapped for several hours, during the night, say from 1 am to 4 am. It becomes apparent that there are repetitive usages, denoted N for a toilet flush (say 7/2 min liters) and M (washing machine 10/30 min liters). Other repetitive usages (not shown, for the sake of simplicity, might be, for example D, dishwasher 20 liters/40 min, S, shower 12 liters, bath, B 25 liters etc.). Upon tracking the section water usage over time, it becomes apparent that there are combination uses such as N, M, 2N, 3N, 2M, M+N and other combinations and permutations. When no apparent usage is observed, a baseline level B1 is seen. B1 represents a low first leakage level in pipe section 106.

Reference is now made to FIG. 2B is a simplified chart 250 of water use and losses over time for a section 140 of mains pipe 105, in accordance with an embodiment of the present invention. Again, it becomes apparent that there are repetitive usages, denoted N for a toilet flush (say 7 liters) and M (washing machine 10 liters). Other repetitive usages (not shown, for the sake of simplicity, might be, for example D, dishwasher 20 liters, S, shower 12 liters, bath, B 25 liters etc.). Upon tracking the section water usage over time, it becomes apparent that there are combination uses such as N, M, 2N, 3N, 2M, M+N and other combinations and permutations. When no apparent usage is observed, a baseline level B2 is seen. B2 represents a high second leakage level in pipe section 140.

Reference is now made to FIG. 2C, which is a simplified chart 270 of water use and losses over time for a section 150 of a mains pipe 105, in accordance with an embodiment of the present invention. Again, it becomes apparent that there are repetitive usages, denoted N for a toilet flush (say 7 liters) and M (washing machine 10 liters). Other repetitive usages (not shown, for the sake of simplicity, might be, for example D, dishwasher 20 liters, S, shower 12 liters, bath, B 25 liters etc.). Upon tracking the section water usage over time, it becomes apparent that there are combination uses such as N, M, 2N, 3N, 2M, M+N and other combinations and permutations. When no apparent usage is observed, a baseline level B3 is seen. B3 represents no leakage in pipe section 150.

As many measurements of leakage flow per pressure heads should be taken in accordance with FIG. 1. For example, starting from 5 meters of pressure head every 2.5 meters until the operational pressure of the pipe section is achieved. Example operating pressure head is 40 meters, measurements should be taken at 5, 7.5, 10, 12.5, up to 40 meters.

The Torricelli orifice equation forms the basis for the pressure-leakage relationship, and can be used to describe the leakage flow rate from an orifice as:

Q=C_{d}A(2gh)^{0.5} [1]

where Q is the leakage flow rate through the orifice; Ca a discharge coefficient; A the leak area; g the acceleration due to gravity; and h the pressure head at the orifice. Van Zyl and Cassa [van Zyl, J. E., & Cassa, A. M. (2014). Modeling elastically deforming leaks in water distribution pipes. Journal of Hydraulic Engineering, 140(2), 182-189.] found that the FAVAD model is particularly suited to model individual leaks in elastic materials. Replacing a linear equation for the leak area as a function of pressure into the orifice equation

Q=C_{d}(2g)^{0.5}(A₀h^{0.5}+mh^{1.5}) [2]

where A₀ is the leak area intercept; and m is the head-area slope. This relationship states that leaks are not considered either fixed or variable, but that all leaks are considered variable. In other words, all leaks will increase in area to A=A₀+mh with increasing pressure head where m can take on positive and sometimes negative values. By substituting:

k₁=C_{d}A₀(2g)^{0.5} [3]

and

k₂=C_{d}m(2g)^{0.5} [4]

we arrive at

Q=k₁h^{0.5}+k₂h^{1.5} [5]

This relationship in the past has been used to predict the reduction of leakage levels in a large pipe zone as a result of reducing the pressure head in the zone, known as pressure reducing measures to mitigate leakage. However, for our purposes we are interested in the elasticity or non-elasticity of a single leak or a single dominate leak in a smaller pipe section.

Noting that k₂/k₁=m/A₀=(A−A₀)/h/A₀=ΔA/A₀/h

we are interested in arriving at the value of ΔA/A₀ which is called herein, an Orifice Area Expansion Factor (OAEF) and which denotes the increase in the area of a leak at pressure head h relative to A₀ which is the stationary area i.e. when h=0. The OAEF therefore provides a measure in % of the increase in area of the leak orifice at the working pressure head which when passing certain thresholds provides the estimated decrease in the probability of achieving an efficient seal. These thresholds in general are to be determined empirically based on real data from the field over time.

OAEF is therefore given by k₂/k₁×h.

For any 2 pairs of pressure head h and leakage flow Q measurements, k₁ and k₂ can be calculated from formula 5 and then averaged over all results. Applying the average k₂/k₁ the OAEF can be calculated for every new pressure head. Results relating to two examples are given in tables below for a 25 mm diameter PE pipe with two different lengths of longitudinal cracks based on real data.

### EXAMPLES

### Example 1

In Example 1, OAEF is calculated for each pressure head and found to be zero in all cases. This is an indication of the non-elasticity of this crack and that no measurable increase of the orifice area occurs despite the increase in pressure. This would be remarkably similar to the behavior of a longitudinal crack in a ferrous pipe. Since OAEF is zero it does not exceed any threshold and the leak orifice would therefore most likely experience an efficient seal.

TABLE 1
data for example 1.
Example 1 PE Pipe
Diameter 25 mm

| Head | Flow | | | | |
|---|---|---|---|---|---|
| (m) | (l/h) | | | | |
| 10 | 156 | k₂ | k₁ | k₂/k₁ | OAEF |
| 15 | 200 | 0.46 | 44.72 | 0.01 | 0% |
| 20 | 220 | −0.49 | 58.98 | −0.01 | 0% |
| 25 | 245 | −0.04 | 49.97 | 0.00 | 0% |
| 30 | 268 | −0.01 | 49.35 | 0.00 | 0% |
| 35 | 283 | −0.22 | 55.49 | 0.00 | 0% |
| 40 | 306 | 0.11 | 44.01 | 0.00 | 0% |
| | | | Average: | 0.00 | |

### Example 2

In Example 2, OAEF is calculated in the same manner but this time is found to increase as the pressure head increases. This is an indication of the elasticity of this crack and that increases of orifice area occur with the increase of pressure. Since OAEF is non-zero it is likely to exceed a threshold and there would be a decrease in the probability of achieving an efficient seal of the leak orifice. This is so since pipe stresses are significantly affected by an expansion of the leak orifice and can easily exceed the material's yield strength in the vicinity of the opening.

TABLE 2
data for example 2.
Example 2 PE
Diameter 25 mm

| Head | Flow | | | | |
|---|---|---|---|---|---|
| (m) | (l/h) | | | | |
| 10 | 465 | k₂ | k₁ | k₂/k₁ | OAEF |
| 15 | 650 | 4.16 | 105.48 | 0.04 | 49% |
| 20 | 815 | 2.88 | 124.60 | 0.02 | 65% |
| 25 | 985 | 2.95 | 123.20 | 0.02 | 81% |
| 30 | 1170 | 3.32 | 113.94 | 0.03 | 98% |
| 35 | 1350 | 2.92 | 126.13 | 0.02 | 114% |
| 40 | 1580 | 4.33 | 76.79 | 0.06 | 130% |
| | | | Average: | 0.03 | |

### Example 3

In cases where more than one leak is measured then the OAEF will provide the desired measure for the aggregate leakage. In example 3, OAEF is calculated for the aggregate leakage of the two leaky orifices associated with Examples 1 and 2. OAEF increases steadily with increasing head since the leaky orifice associated with Example 2 has a more dominant effect than the leaky orifice associated with Example 1.

TABLE 3
data from example 3.
Example 3 PE
Diameter 25 mm

| Head | Flow (l/h) | | | | |
|---|---|---|---|---|---|
| 10 | 621 | k₂ | k₁ | k₂/k₁ | OAEF |
| 15 | 850 | 4.62 | 150.19 | 0.03 | 33% |
| 20 | 1035 | 2.39 | 183.58 | 0.01 | 44% |
| 25 | 1230 | 2.91 | 173.17 | 0.02 | 55% |
| 30 | 1438 | 3.31 | 163.29 | 0.02 | 66% |
| 35 | 1633 | 2.70 | 181.63 | 0.01 | 77% |
| 40 | 1886 | 4.44 | 120.80 | 0.04 | 88% |
| | | | Average: | 0.02 | |

An example of theoretical thresholds which are empirically determined are given below in Table 4.

TABLE 4
empirical data of theoretical thresholds and probabilities of efficient
seal formation based on ranges of values of OAEF.

| | Orifice Area | | |
|---|---|---|---|
| | Expansion | | Probability of |
| Threshold | Factor OAEF | Level of structual Integrity | efficient seal |
| Threshold 1 | From 0% to | Leak orifice is structually | 90% to 100% |
| | 10% | sound | |
| Threshold 2 | From 11% to | Leak orifice has varied | 70% to 90% |
| | 70% | levels of structual integrity | |
| Threshold 3 | From 71% to | Leak orifice has limited | 30% to 70% |
| | 100% | structual integrity | |
| Threshold 4 | Above 100% | Leak orifice has low | Low probability |
| | | structual integrity | of efficient seal |

However, the underlying assumption in formulas 1 and 2 is that Ca the discharge coefficient is constant and does not change with pressure head which is not always the case and for which the validity of OAEF comes into question. Therefore, there is a need to quantify the constraints for which OAEF is valid. In accordance with formula 2 if m is large enough then the leakage flow rate Q becomes proportional to h^{1.5}. However, in practice it is found that the relationship between Q and h can also be described by the following exponential relationship:

Q=Ch^{N1}

where the leakage exponent N₁ can take on values as high as 2.79. Since OAEF loses its validity for values of N₁=1.5 and above it is useful to first validate OAEF values by calculating N₁ for each case and testing against the threshold of 1.5.

### Example 4

Below is a repeat of examples 1 and 2 with the validation figures for N₁. Example 4 is given where N₁ is above 1.5 for a particular entry rendering OAEF non valid for this entry. The average k₂/k₁ value in this case is achieved by omitting the h=45 meters entry (since N₁=1.52). For all other entries where N₁<1.5 the OAEF values are valid.

TABLE 5
data for example 4.
Example 4 PE (polyethylene)

| | 25 mm | | | | | |
|---|---|---|---|---|---|---|
| Head (m) | Flow (l/h) | OAEF Validation | | | | |
| 10 | 465 | N₁ | k₂ | k₁ | k₂/k₁ | OAEF |
| 15 | 650 | 0.826051 | 4.16 | 105.48 | 0.04 | 49% |
| 20 | 815 | 0.786339 | 2.88 | 124.60 | 0.02 | 65% |
| 25 | 985 | 0.849021 | 2.95 | 123.20 | 0.02 | 81% |
| 30 | 1170 | 0.944032 | 3.32 | 113.94 | 0.03 | 98% |
| 35 | 1350 | 0.928318 | 2.92 | 126.13 | 0.02 | 114% |
| 40 | 1580 | 1.178152 | 4.33 | 76.79 | 0.06 | 130% |
| 45 | 1890 | 1.521034 | 6.38 | −5.58 | −1.14 | Non- |
| | | | | | | valid |
| | | | | Average: | 0.03 | |

In addition, OAEF is meaningful only if N₁ does not consistently decrease with increase of head pressure. A consistent decrease with increase of head pressure is indicative of a transition from linear flow to turbulent flow through the leaky orifice and has no direct impact on said orifice's structural integrity.

Example 5 is given for aggregate leakage from asbestos cement (AC) pipe collars where N₁ demonstrates a consistent decrease rendering OAEF non meaningful for all entries. The significance is that based on the disclosed embodiment no issues with structural integrity are identified with these collars.

TABLE 6
data for example 5.
Example 5 AC Pipe

| Diameter | 150 mm | | | | | OAEF is |
|---|---|---|---|---|---|---|
| Head | Flow | | OAEF | | | not |
| (m) | (l/h) | | Validation | | | Meaningful |
| 5.5 | 3000 | N₁ | k₂ | k₁ | k₂/k₁ | OAEF |
| 6.2 | 4500 | 3.38 | 754.34 | −2869.68 | −0.26 | 52% |
| 10 | 8000 | 1.20 | 190.15 | 628.30 | 0.30 | 84% |
| 15 | 12700 | 1.14 | 149.86 | 1031.21 | 0.15 | 126% |
| 20 | 16100 | 0.82 | 64.19 | 2316.30 | 0.03 | 167% |
| 25 | 19200 | 0.79 | 47.99 | 2640.35 | 0.02 | 209% |
| 35 | 23900 | 0.65 | 19.98 | 3340.41 | 0.01 | 293% |
| 48 | 28800 | 0.59 | 9.01 | 3724.61 | 0.00 | 402% |
| | | | | Average: | 0.08 | |

### Example 6

1) In a first step, using the system as described in FIG. 1, a pre-intervention leakage level is determined to be 800 liters/hour.
2) In a second step, an intervention is taken to stop the leakage, such as, but not limited to, the methods described in U.S. Pat. Nos. 10,302,235, 10,288,206 and 10,302,236.
3) In a third step, using the system as described in FIG. 1, a post-intervention leakage level is determined and found to be 100 liters/hour.

Thus, the total leakage reduction achieved in this example is 700 liters/hour, or a percent leakage reduction=87.5%.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

What is claimed is:

1. A method for measuring a fluid leakage volume in a pipeline network, the method comprising:
isolating a section of the pipeline network;
introducing fluid into the isolated section via a conduit including a flowmeter and pressure sensor;
applying a plurality of externally controlled pressures to the isolated section;
measuring corresponding leakage flowrates at each of said pressures;
determining a relationship between pressure and leakage flowrate; and
deriving, from said relationship, a parameter indicative of structural behavior of a leak in the pipeline section, wherein the leakage volume is determined based on said relationship.

2. A method according to claim 1, wherein said pipeline network is at least partially one of underground and underwater.

3. A method according to claim 2, wherein said pipeline network is at least one of underground and underwater.

4. A method according to claim 1, further comprising measuring pressure of said pressure point in said pipeline complex using said pressure sensor.

5. A method according to claim 1, wherein said valves comprise a water inlet valve at a first end of a conduit, and wherein said pressure sensor and said fluid flowmeter are in fluid connection with said conduit.

6. A method according to claim 1, wherein said conduit is in fluid connection with said pipeline network at a second end thereof.
